(19) United States
(12) Patent Application Publication
(10) Pub. No.: US 2001/0022785 A1
(43) Pub. Date: Sep. 20, 2001

(54) Control of application-specific quality of service optimizations

(76) Inventor: Pekka Tapio Pessi, Helsinki (FI)

Correspondence Address: Clarence A. Green, Perman & Green, LLP, 425 Post Road, Fairfield, CT, 06430, US

(21) Appl. No.: 09/802,621

(22) Filed: Mar. 9, 2001

(30) Foreign Application Priority Data
Mar. 10, 2000 (FI) 20000566

(51) Int. Cl. H04L 12/66

(52) U.S. Cl. 370/352; 370/389

(57) ABSTRACT

The invention relates to a method for application-specific quality of service optimization, in which method the processing of data streams coming from said application is optimized in nodes (2a, 2b, 2c, 2d) between a sender (1a) and a receiver (1b) in a communication network. In this communication network, at least one quality of service signalling protocol is used. The application uses this quality of service signalling protocol to mark application-specific data streams, wherein the nodes (2a, 2b, 2c, 2d) of the communication network identify, on the basis of the quality of service signalling, packets (3) belonging to the data stream of said application, and their type, wherein these packets (3) are subjected to optimization methods characteristic to this type.

The present invention relates to a method for controlling application-specific quality of service optimizations by using signalling protocols of a general quality of service level, as set forth in the preamble of the appended claim 1. The invention also relates to a signalling protocol for a quality of service as set forth in the preamble of the appended claim 10.

In communication networks, such as TCP/IP networks (Transmission Control Protocol/Internet Protocol), there are various quality of service (QoS) signalling protocols available, such as RSVP (Resource ReSerVation Protocol) and DiffServ (Differentiated Services). These protocols are used to communicate to nodes in the communication network how to proceed in the processing of certain packets. This means, for example, that these packets should be routed along a different route, that the routers should assort these packets to a sequence suitable for them, or that these packets should be transmitted by using a different link or link level service (for example, in the case of ATM, a different virtual connection).

The above-listed operations related to the quality of service are independent of the application, but there are also operations which are characteristic to different applications, i.e. application-specific operations, which affect the quality of service. As an example, RTP-specific optimization (Transport Protocol for Real-Time Applications) can be mentioned, i.e. RTP header compression.

In addition to header compression, it is possible to use several different RTP-specific methods for optimizing the performance. A bar to using them is that it is difficult for a node in the communication network to detect an RTP stream from the other communication in a reliable way. This is due to the fact that there are no specific ports or reliably identifiable individual header fields in the RTP. For this reason, it is not worth-while to start RTP-specific optimization for a certain data stream. It can be even impossible, for example, if RTP optimization changes the route of the communication.

The problem is that the nodes of the communication network cannot identify RTP packets in a reliable manner by using general and straightforward methods. Normally, certain applications are distinguished from other communication in that they use a certain port of the communication protocol (for example, the HTTP uses TCP port 80), or their header fields can be identified. Even though it is recommended that the applications use the UDP port 5004 for RTP communication, in practice, randomly selected port numbers are used with the RTP. This is because one application normally comprises several different data streams which each use a different UDP port, and furthermore, several applications can use the RTP simultaneously in the same computer. Similarly, the RTP header is very simple, and most of the values therein are random by nature.

One way of identifying the RTP data stream in a reliable manner is to examine the protocol of the session level. In the protocol of the session level (for example, H.245 or SDP), the IP addresses and ports used by the RTP connections belonging to the session are transmitted, as well as the codecs and packet sizes used. The problem is that the packets of the protocol of such a session level are typically passed on a different route than the RTP connection, and that the packets are typically encrypted from one end to the other.

According to prior art, however, it can be normally assumed that RTP header compression or RTP multiplexing can be applied directly in the RTP source or in the node preceding the RTP receiver. In this case, the source or the receiver can use link layer specific signalling to activate header compression or multiplexing at the other end of the connection. It is possible in the communication network to broadcast information that if header compression is used in the data stream to be received, the node of the communication network can also use header compression in the same data stream when it is transmitted through another link.

If the application is not capable of signalling the RTP stream in the communication network, but it can only manage a link which is directly coupled to a computer in which the application is being run, RTP header compression can only be used at the edges of the communication network. According to prior art, RTP multiplexing can only be used between devices with several point-to-point connections therebetween. It is thus not possible to use RTP multiplexing e.g. between two routers between which several RTP streams are passed.

It is an aim of the invention to provide a method whereby it is possible to start application-specific traffic optimizations in nodes, such as routers, in the communication network between the sender and the destination.

This aim can be achieved in such a way that the application uses quality of service (QoS) signalling protocols to indicate application-specific data streams. Thus, on the basis of QoS signalling, the nodes of the communication network can identify data streams of the application, wherein it is possible to start application-specific optimization, such as RTP header compression or multiplexing, even before the application has started any actual communication.

To put it more precisely, the method according to the invention is characterized in what will be presented in the characterizing part of claim 1. The QoS signalling protocol according to the invention is characterized in what will be presented in the characterizing part of claim 10.

Significant advantages are achieved with the present invention as compared with solutions of prior art. When the character of a data stream (e.g. RTP) can be signalled to nodes (e.g. routers) between the sender and the destination, several data stream specific optimizations become possible. Further, such signalling makes optimization to the standard interface (API, Application Programming Interface) possible for applications. Thus, the application can be used unchanged in subnetworks of different types, such as PPP, GPRS, WLAN.

In the following, the invention will be described in more detail with reference to the appended drawings, in which

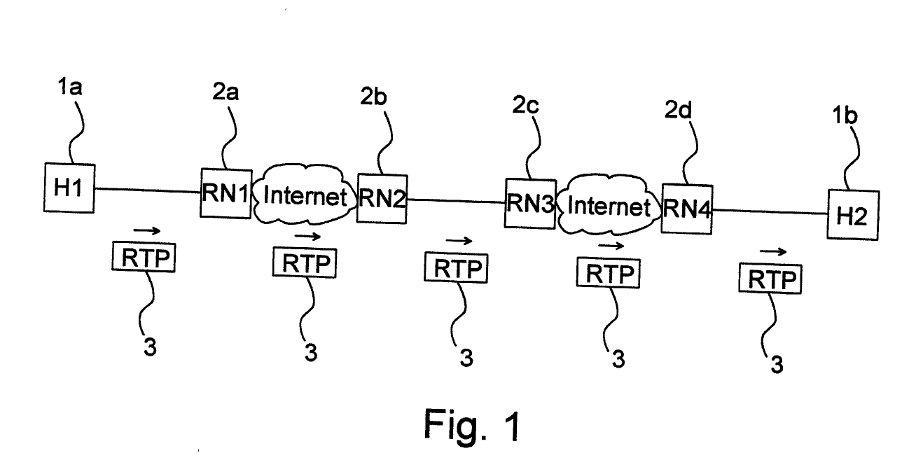

FIG. 1 shows, in a principle diagram, a situation in which a first computer H1 transmits an RTP stream to another computer H2 over a communication network,

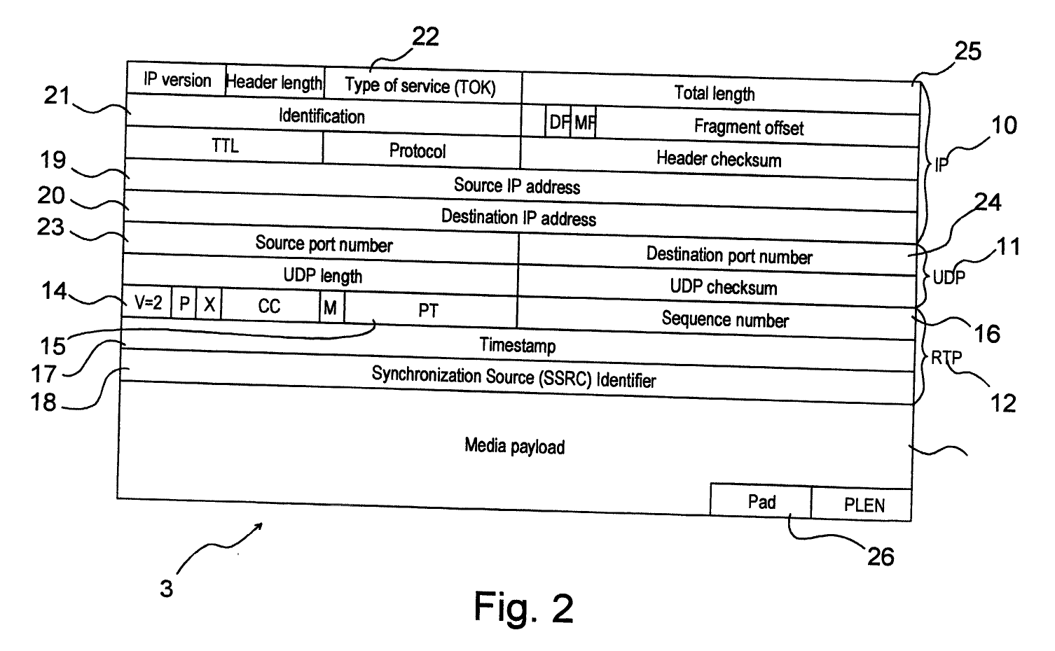

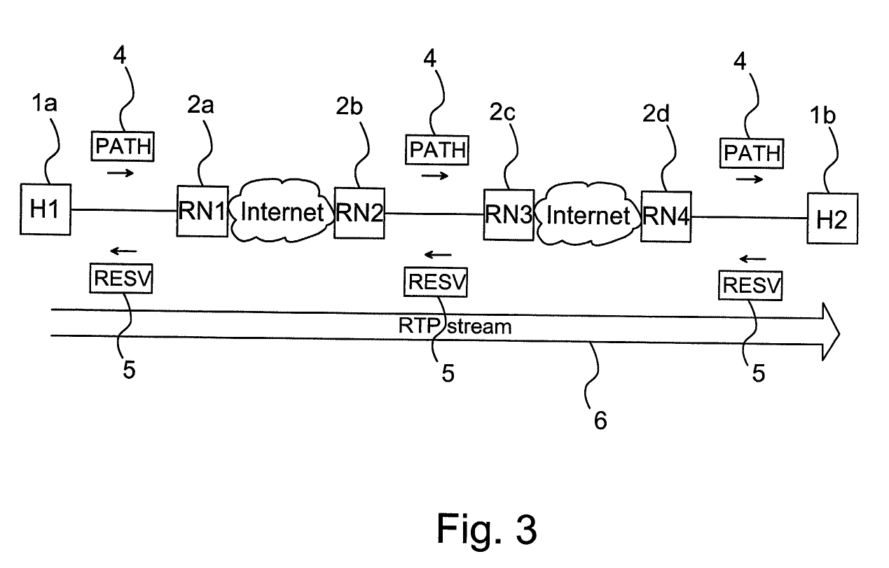

FIG. 2 shows an RTP packet passed in the communication network, FIG. 3 shows, in a principle diagram, a situation in which RSVP is used together with the RTP, and

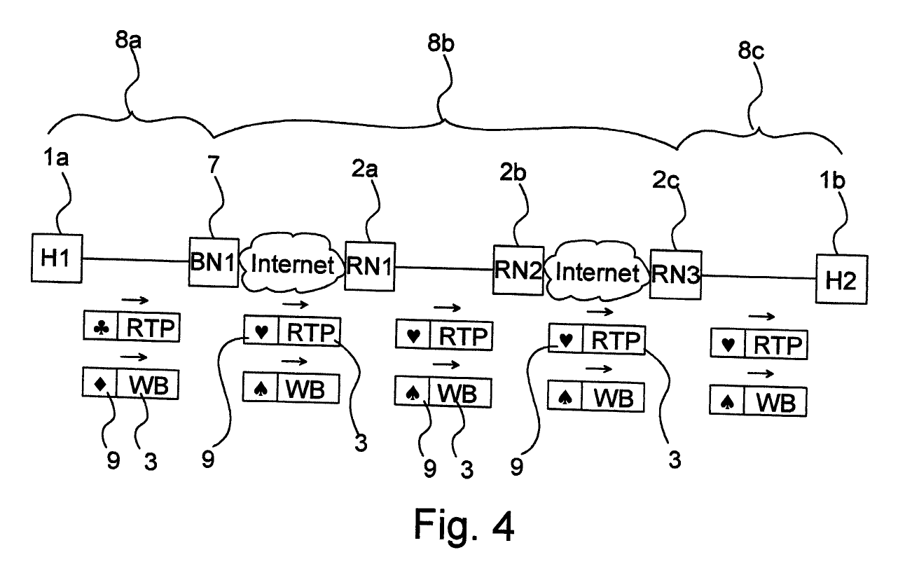

FIG. 4 shows, in a principle diagram, a situation in which DiffServ is used together with the RTP. Different quality of service classes are indicated in the figure with symbols [symbol] , [symbol] , [symbol] , and [symbol] .

The RTP is a simple protocol which adds an RTP header 12 having a length of 12 octets in front of the payload. This header, which is shown in FIG. 2, comprises e.g. a version number 14, a payload type identifier 15 (PT), a sequence number 16, a time stamp 17, and a synchronization source identifier 18. There are no source or destination addresses, wherein a transportation protocol underneath the RTP is used for addressing, such as UDP (User Datagram Protocol), TCP (Transmission Control Protocol), or ATM-AAL5 (Asynchronous Transfer Mode Adaptation Layer type 5).

To support the operation of the RTP, RTCP control protocol (Real-Time Transport Control Protocol) is normally used. The RTCP is used for synchronization of the RTP streams, as well as for controlling delay variation and packet loss. RTCP communication typically consists of transmission and reception reports. RTP communication and the related RTCP communication are called RTP/RTCP. However, all RTP applications do not use the RTCP; its use is optional. In RTP transmission, the port numbers of RTP communication above the UDP are even numbers, and the port numbers of RTCP communication supporting the RTP are one greater and odd numbers.

With reference to FIG. 1, a first computer 1a transmits an RTP stream to a second computer 1b. The transmission process itself is relatively simple. A real-time application receives a payload 13 from a codec (not shown in the figure) and provides it with an RTP header 12 which comprises e.g. a current time stamp 17, a sequence number 16 and a source identifier 15 (a 32-bit random number). Next, when the abovementioned application transmits the packet to the TCP/IP, the TCP/IP provides the received packet with UDP and IP headers and transmits it to the second computer 1b. FIG. 2 shows this packet 3 to be transmitted, comprising an IP header 10, a UDP header 11, an RTP header 12, a payload 13 (Media payload), and possibly filler octets 14 (Pad).

The payload 13 which is transmitted across the RTP can be very short. In such cases, the RTP, UDP and IP headers 10, 11 and 12 represent a major part of the size of the whole packet 3, e.g. 40 bytes in the case of IPv4.

RTP header compression can be used e.g. with a link of a slow rate. RTP header compression does not transfer constant header parts, such as source IP address 19 and destination IP address 20, after the compressed content has been completed. Variable fields, such as RTP time stamp 17, sequence number 16, or IP identification 21, are compressed either by transmitting the difference between consecutive values or by utilizing the information that the difference is constant.

Some link layer applications determine a minimum size for a packet, e.g. 64 octets in the Ethernet or 512 octets in the Gigabit Ethernet, wherein header compression may not be sufficient as such. Normally, in packet-switched communication networks, a certain regular time is used for processing of each packet, wherein reducing the number of packets will increase the capacity of the communication network. In this case, a suitable way of optimization is to multiplex several RTP connections in one network layer connection. When several RTP packets can be transmitted in one network layer packet 3, the communication network is deloaded and, moreover, the share of the headers in the total communication is reduced. In a multiplexed connection, the end points negotiate the parameters of the multiplexed connections in such a way that RTP streams identical with the original can be reconstructed after demultiplexing.

A data stream that is transmitted over the RTP will normally require a different performance than other traffic in the communication network.

The RTP stream is considerably more susceptible to lost packets and delays than regular communication using e.g. the TCP. To achieve sufficient quality of service, it would be preferable that the application using the RTP would also use QoS mechanisms offered by the communication network. Using these QoS mechanisms requires some kind of signalling; for example, the application must inform the communication network of the packets to be allocated priority. For signalling, it is possible to use e.g. the RSVP or the TOS octet of DiffServ.

As a result of QoS signalling, intermediate nodes 2a, 2b, 2c and 2d of the communication network (FIG. 1) can treat packets 3 of the data stream in a desired way. The intermediate nodes can identify packets belonging to the data stream, buffer them and transfer them, taking into account the QoS requirements set by the application by means of QoS signalling.

QoS signalling can also start RTP-specific optimization, such as header compression or multiplexing. The starting can be either explicit or implicit. In the explicit case, a certain QoS class or data stream definition will only apply to RTP communication. In the implicit case, the intermediate nodes 2a, 2b, 2c, 2d can use QoS signalling as auxiliary information upon determining whether or not optimization is to be applied for a certain data stream.

The invention is not limited to any specific signalling protocol, but it can be utilized in connection with any QoS signalling. In the following, the invention will be described by using as examples the two most common QoS signalling protocols: RSVP and DiffServ. These protocols are selected as examples, because they represent two different types of signalling. They are also used to point out that the invention can be used in the case of various types of signalling protocols.

In the RSVP, service reservation takes place according to the following description, with reference to FIG. 3. A source node 1a transmits a Path message 4 downstream towards a destination 1b, i.e. in the direction of an RTP stream 6. All the nodes 2a, 2b, 2c, 2d between the source and the destination which can process the RSVP, receive this Path message 4, open a path for the data stream, add their own address in the message, and transmit the message further towards the destination 1b.

The source 1a describes the data stream properties in a Tspec object in the Path message 3, determining the normal transmission rate of the data stream (in bytes per second) and burst rate (maximum rate in bytes per second and buffer size in bytes). A SENDER_TEMPLATE object is used in the message to indicate the address of the sender of the data stream, and a SESSION object is used to indicate the address of the destination of the stream. The nodes 2a, 2b, 2c, 2d between the source 1a and the destination 1b can add QoS resource definitions and the available properties in an ADspec object in the Path message. Consequently, when arriving at the receiver 1b, the Path message contains a data stream description (Tspec) and a description on the QoS resources available on the route (ADspec).

After receiving the Path message 4, the receiving computer, i.e. the destination node 1b, can reserve the QoS resources. To be successful, the destination transmits a Resv message 5 back upstream, towards the source 1a. This Resv message contains a description on the service that the receiver expects. The desired service is described in a flowspec object in the Resv message, consisting of Tspec and Rspec objects. On the basis of this, each intermediate node 2a, 2b, 2c, 2d reserves the desired resources and transmits the message further upstream (towards the sender) on the basis of the address in the Path message 4. When the reservation has been made along the whole route, the source 1a can transmit an acknowledgement on the reservation with a ResvConf message (not shown). Normally, the ResvConf message is transmitted to the destination 1b the stream, to inform the destination that the reservation has been made. After this, when the packet 3 (FIG. 1) arrives at a node in the communication network, the type of the data contained in this packet can be identified, wherein it is possible to subject this packet to optimization methods typical for this type.

The RSVP is object-oriented, which means that all the nodes 2a, 2b, 2c, 2d processing RSVP messages do not need to understand or process all the fields in the messages. The nodes which are not capable of processing some fields will only transmit them further. The fields, or objects, in the RSVP are constructed to be easily expanded. It is possible to determine new services which are signalled by using the RSVP without changing the basic structure of the protocol or the implementation of existing services (e.g. controlled load service, guaranteed service) in nodes which do not support new services.

The expansions to be made in the RSVP are presented as follows:

The source 1a indicates in Tspec that the suggested data stream is RTP/RTCP. This is needed e.g. when the path of the traffic is changed as a result of tunneling in multiplexed connections.

The nodes 2a, 2b, 2c, 2d between the sender 1a and the destination 1b can indicate what kind of RTP/RTCP-specific QoS optimization they can implement in ADspec.

The destination 1b indicates in flowspec that the data stream is RTP/RTCP.

The easiest way of implementing RTP support is to add new application-specific service parameters preferably in the existing description of services. The application-specific service parameters can contain flags indicating what kind of processing the destination 1b will need to receive the data stream successfully. For example, it is possible to introduce IP header compression, UDP header compression and RTP header compression. The application-specific service parameters can also contain the necessary information to invoke optimization even before any communication has been received.

In the following, the invention will be described in the case of DiffServ with reference to FIG. 4. DiffServ has no specific signalling messages but the desired QoS classes are indicated with various marks in a DS field (as the DS field in the IPv4, a TOS octet 22 is used in FIG. 2) in an IP header 10. A signalling message 9 is conveyed with the packet 3 itself. The QoS classes are only valid within a certain operating range 8a, 8b, 8c. A terminal node 7 which is at the boundary between two different operating ranges 8a, 8b classifies incoming packets into different QoS classes and marks them with a mark corresponding to each QoS class (code point). This classification can be performed in this terminal node on the basis of various ways. The application can use a signalling protocol, e.g. the RSVP, to indicate the required classification parameters to the terminal node, or the application itself can use e.g. in the case of IPv4 the TOS octet 22 (Type of service) to mark the RTP packets 3. By means of this, the terminal node can reliably identify the RTP packets and mark them with a suitable value in the DS field. When any of the other nodes 2a, 2b, 2c in the communication network receives a packet using the RTP, it can safely use optimization ways characteristic to this type.

FIG. 4 shows an example of DiffServ. In this example, an IP call comprises two UDP data streams, one of them conveying sound by using the RTP (marked as RTP in the figure) and the other conveying data of a white board application without the RTP (marked as WB in the figure). The terminal node 7 classifies the RTP stream into the RTP class and marks it with the symbol of the RTP class ( [symbol] ). It classifies the white board data into a real-time class and marks it with the symbol of the real-time class ( [symbol] ). The other nodes 2a, 2b, 2c of the communication network will only use RTP header compression for data streams marked with the symbol of the RTP class ( [symbol] ).

If there is no separate service class available for the RTP but there is a common real-time service class available, for example VoIP (Voice over IP), the nodes 2a, 2b, 2c, of the communication network (FIG. 4) can use the service class as auxiliary information when determining if the data stream comprises RTP communication. For example in the case of FIG. 4, if the sound were marked as belonging to the real-time service class, the nodes 2a, 2b, 2c of the communication network could identify the sound as an RTP stream on the following grounds. On the basis of the TOS octet 22, the packets belong to the real-time service class, the source port number 22 and the destination port number 24 match, the total packet length 25 is substantially constant, the RTP version number 14 is 2 (V=2), the RTP sequence number 16 and the RTP time stamp 17 grow in a monotonous manner, and the payload type 15 (PT) and the synchronization source identifier 18 remain constant.

The present invention is not limited solely to the embodiments presented above, but it can be modified within the scope of the appended claims.

1. A method for application-specific quality of service optimization, in which method the processing of data streams coming from said application is optimized in nodes (2a, 2b, 2c, 2d) between a sender (1a) and a receiver (1b) in a communication network, in which communication network at least one quality of service signalling protocol is used, characterized in that the application uses said at least one quality of service signalling protocol to mark application-specific data streams, wherein the nodes (2a, 2b, 2c, 2d) of the communication network identify, on the basis of the quality of service signalling, packets (3) belonging to the data stream of said application, and their type, wherein these packets (3) are subjected to optimization methods characteristic to this type.

2. The method according to claim 1, in which method packets (3) of at least one type are transmitted in the communication network, characterized in that said signalling protocol used is a quality of service signalling protocol which comprises a description of the type of the packets.

3. The method according to claim 1 or 2, in which method the quality of service is optimized, characterized in that the signalling protocol used is a quality of service signalling protocol which comprises parameters required in optimizations.

4. The method according to claim 1, 2 or 3, characterized in that application-specific signalling is used for optimization of a data stream of a real-time application in the nodes (2a, 2b, 2c, 2d) in the communication network.

5. The method according to claim 4, characterized in that application-specific optimization is used for optimization of an RTP stream (6).

6. The method according to any of the claims 1 to 5, characterized in that the application sets up, by means of signalling messages (4, 5) of the signalling protocol, an optimized path between the sender (1a) and the receiver (1b) for a data stream (6) of the application, wherein the optimized quality of service required by the application is reserved at each node (2a, 2b, 2c, 2d) of the communication network.

7. The method according to claim 6, characterized in that the signalling protocol used is the RSVP, wherein Path (4), Resv (5) and ResvConf messages are used to reserve an optimized path for the data stream (6) of the application between the sender (1a) and the receiver (1b).

8. The method according to any of the claims 1 to 5, in which method the application transmits packets (3), characterized in that the application supplements the packet (3) to be transmitted with a signalling message (9), on the basis of which each reached node (2a, 2b, 2c) of the communication network can perform signalling.

9. The method according to claim 8, characterized in that the signalling protocol used is DiffServ, wherein the signalling message (9) is conveyed with the packet (3) itself in the DS field (22) of the packet, in the IP header (10), by means of which each reached node (2a, 2b, 2c) of the communication network can perform optimization.

10. A quality of service signalling protocol which is arranged to transmit signalling messages to nodes (2a, 2b, 2c, 2d) in a communication network and which quality of service signalling protocol comprises means for marking a data stream of a certain application, means for transmitting the type of said data stream, and means for transmitting optimization parameters, characterized in that the quality of service signalling protocol is arranged to mark the data streams belonging to said application for the nodes (2a, 2b, 2c, 2d) of the communication network, wherein these nodes (2a, 2b, 2c, 2d) of the communication network are arranged to identify these data streams and to use optimization methods characteristic to each type for these data streams.
